(19) United States
(12) Patent Application Publication
(10) Pub. No.: US 2011/0095563 A1
(43) Pub. Date: Apr. 28, 2011

(54) VEHICLE UNDERBODY AIRFLOW MODULATOR

(76) Inventor: Stanley Andersen, Stevenson, WA (US)

(21) Appl. No.: 12/913,280

(22) Filed: Oct. 27, 2010

Related U.S. Application Data
(60) Provisional application No. 61/255,328, filed on Oct. 27, 2009.

(51) Int. Cl. B62D 35/02

(52) U.S. Cl. 296/180.1

(57) ABSTRACT

Methods and apparatuses for decreasing automotive drag in vehicles are provided herein. In embodiments, a vehicle underbody airflow modulator may comprise one or more flexible panels and fasteners. A flexible panel may be retained below the underbody of a vehicle, covering one or more features of the underbody and preventing disruption of airflow by the features. In some embodiments, a tensioning device may be provided to tension the panel. Various embodiments may permit access to the vehicle underbody, dampen road noise, and/or decrease high speed vehicle lift, and may be made available at a lower initial cost than current alternatives.

### RELATED APPLICATIONS

This application claims priority to U.S. Provisional Patent Application No. 61/255,328, filed Oct. 27, 2009, the entire disclosure of which is hereby incorporated by reference herein.

### TECHNICAL FIELD

Embodiments herein relate to the field of vehicles and related aerodynamics, and, more specifically, to a vehicle underbody airflow modulator.

### BACKGROUND

Fuel efficiency in automobiles is adversely affected by aerodynamic drag. Modern automobiles are designed with some features to reduce drag, such as reduced frontal areas and inclined windshields. However, the goal of drag reduction may sometimes be sacrificed in order to maximize stability, minimize vehicle lift and reduce yaw. While a vehicle owner may add various after-market features to an automobile to enhance speed and other performance parameters, minimization of aerodynamic drag is generally left to the designer of the vehicle.

### BRIEF DESCRIPTION OF THE DRAWINGS

Embodiments will be readily understood by the following detailed description in conjunction with the accompanying drawings. Embodiments are illustrated by way of example and not by way of limitation in the figures of the accompanying drawings.

FIGS. 1a-1b illustrate vehicle underbody panels in accordance with various embodiments;

FIGS. 2a-2c illustrate multi-section vehicle underbody panels in accordance with various embodiments;

FIG. 3 illustrates a cutaway profile view of a vehicle underbody airflow modulator positioned on a vehicle chassis in accordance with various embodiments;

FIG. 4 illustrates a partial cutaway perspective view of a tensioning device for use with a vehicle underbody panel in accordance with various embodiments;

FIG. 5 illustrates a partial plan view of a tensioning device for use with a vehicle underbody panel in accordance with various embodiments; and

FIG. 6 illustrates a method for reduction of aerodynamic drag on a vehicle in accordance with various embodiments.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “NB” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments, are synonymous.

As used herein, the term “panel” may refer to a portion of a vehicle underbody panel that is configured to be retained in a substantially aligned, such as a planar, multi-planar, or parallel, position below a chassis of a vehicle. Panels in accordance with various embodiments may comprise or be constructed of any flexible material including, but not limited to, a polymer/copolymer, a plastic, a fabric, a resin, an elastomer, and/or a flexible woven material. For example, a panel may comprise one or more of vinyl, polyester, vinyl polyester, polychloroprene, polypropylene, nylon, neoprene nylon, elastane, carbon fiber, rubber, polyurethane, polyurea, polyethylene, polytetrafluoroethylene, and/or polyvinyl chloride, alone or in any combination. A panel may comprise synthetic, artificial, and/or natural fibers. A panel may include one or more rigid or semi-rigid portions, such as ribs or reinforced portions to strengthen the panel. In some embodiments, a panel may comprise one, two, three or more layers.

Panels and/or materials used in the construction of panels may be selected, altered, or treated to impart or improve characteristics such as weather resistance (e.g. heat/cold resistance, water resistance, wind resistance, resistance to UV/light damage), chemical resistance (e.g. resistance to oil, antifreeze, window cleaner, brake fluid, detergents, organic solvents, etc.) toughness, puncture resistance, flexibility, resistance to cracking, elasticity, reflectivity, insulating properties (e.g. conduction of sound, heat, etc.), weight/density reduction, friction reduction, thickness, color, surface texture, and/or other characteristics.

In an embodiment, a panel may be constructed from a heat resistant material and/or may be constructed with an integrated heat shield to prevent damage from certain areas of a vehicle underbody, such as a muffler. A suitable heat shield may be an integrated metallic portion. A heat shield may be configured to reside close to the underbody or to be spaced from the underbody by one or more spacing elements.

For certain vehicles, it may be beneficial for a panel to have one or more openings to permit passage of a controlled volume of air to pass between the panel and the vehicle underbody to provide cooling, such as to the transmission lines. This may be accomplished by providing a small openings, flaps, or air scoops to redirect air flow along the transmission lines or to other portions of the underbody in need of cooling.

As used herein, the term “fastener” may refer to any item, material or device used for mechanically coupling two or more components of a vehicle underbody panel and/or mechanically coupling a component of a vehicle underbody panel to a vehicle or vehicle component. “Fastener” is intended to encompass permanent fasteners and releasable fasteners. A “fastener” may provide a flexible/articulated coupling of two items, an inflexible/non-articulated coupling of two items, and/or a stretchable coupling such that the coupled items may be moved apart without releasing/removing the fastener. Fasteners may include adhesives, rivets, welds, seams/stitches, clips, clekos, magnets, suction devices, cam dowels/locks, ties, snaps, bolts/screws/studs, clasps, clamps, buckles, pins/pin fasteners, grommets, zippers, elastic bands, hook-and-loop, buttons, hinges, anchors, rings, straps, staples, pegs, interlocking surface/edge features, etc. A panel may include one, two or more types of fastener(s) in cooperation and/or disposed in varying locations along the panel. Fasteners may be used in any suitable number or combination. In addition, a fastener may be formed as an integral part of a panel, a vehicle, and/or a component of a panel/vehicle. Embodiments herein provide methods, apparatuses and systems for a vehicle underbody airflow modulator. Aerodynamic efficiency is expressed in terms of the “drag coefficient,” or “Cd.” The Cd. of modern production automobiles is quite efficient in most areas but this is not true of the underbelly. This problem has been overcome in some non-production automobiles, for which custom built, bolt-on belly pans have been designed.

Bolt-on belly pans are impractical for use in production vehicles for several reasons. First, the addition of the belly pan makes the underbelly of the vehicle difficult to access for service and repairs, and is therefore too labor-intensive to use on production vehicles. The vehicle owner is inconvenienced not only by the downtime experienced during installation of the belly pan, but also by the additional time required for servicing the vehicle after the installation. In addition, the purchase and installation of the belly pan may be cost-prohibitive, especially if a bolt-on belly pan has not previously been designed for the make and model of the vehicle.

Embodiments of a vehicle underbody airflow modulator as described herein may permit easy access to the underside of a vehicle for service and repairs, and may be made available at a lower initial cost than custom-built bolt-on belly pans. A vehicle underbody airflow modulator may include, for example, one or more panels and at least one coupling element configured to couple the panel to the underside of a vehicle. In accordance with embodiments of the current disclosure, a vehicle underbody airflow modulator may be used to decrease fuel consumption in vehicles designed for highway use by minimizing Cd. In addition, embodiments as described may provide additional benefits such as dampening road noise and counteracting high speed vehicle lift.

As used herein, an “end” of a vehicle may be any terminal portion of the vehicle, including but not limited to a front or rear bumper, a rocker panel, a trunk, or any component attached to an exterior surface of the vehicle. In addition, any component that is coupled to a vehicle “near” an “end” of the vehicle may be coupled to any of these terminal portions of the vehicle, or coupled to other portions of the vehicle proximal to any of the terminal portions. For example, an “end” of a vehicle may be a front bumper, and a component coupled “near” this “end” may be coupled to a hood, a grill, a fender, or a portion of the underbody located forward of the rear wheels. As another example, another “end” of the vehicle may be a rear bumper or portion of the trunk, and a component coupled “near” this “end” may be coupled to the rear bumper, the trunk, or a portion of the underbody located rearward of the front wheels.

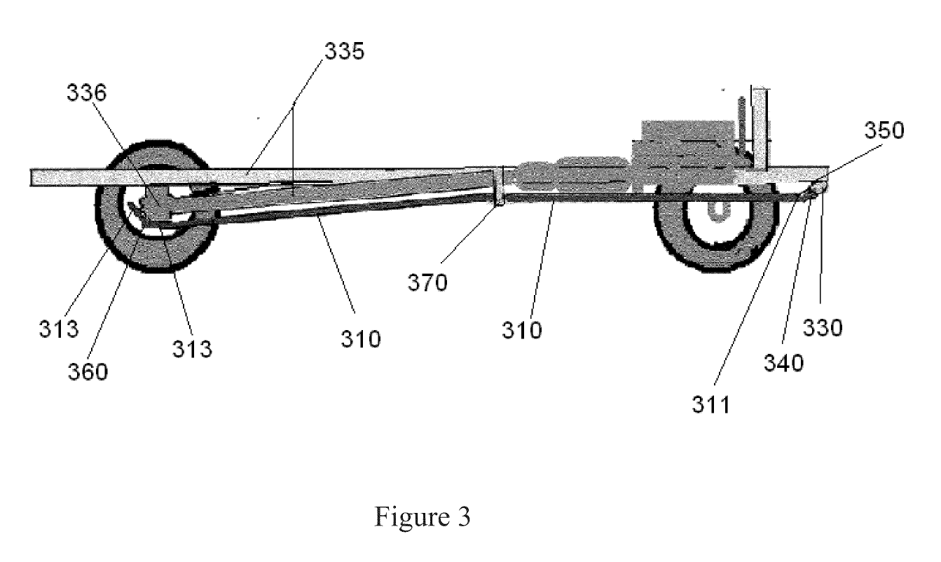

In accordance with various embodiments, a panel of a vehicle underbody airflow modulator may be positioned below a vehicle in a “substantially planar configuration,” meaning that one or more portions of the panel may assume a relatively flat configuration. In some examples, one or more portions of a panel may be retained in a position “substantially parallel to an underbody surface of the vehicle,” meaning that the panel extends along a plane that is substantially parallel to the plane of an outer surface of the underbody, such as a lower surface of the vehicle chassis or a lower surface of a rocker panel. In some examples, some portion of the panel may extend along a plane parallel to the plane of the road/ground and/or oblique to the plane of the road/ground (see e.g., FIG. 3).

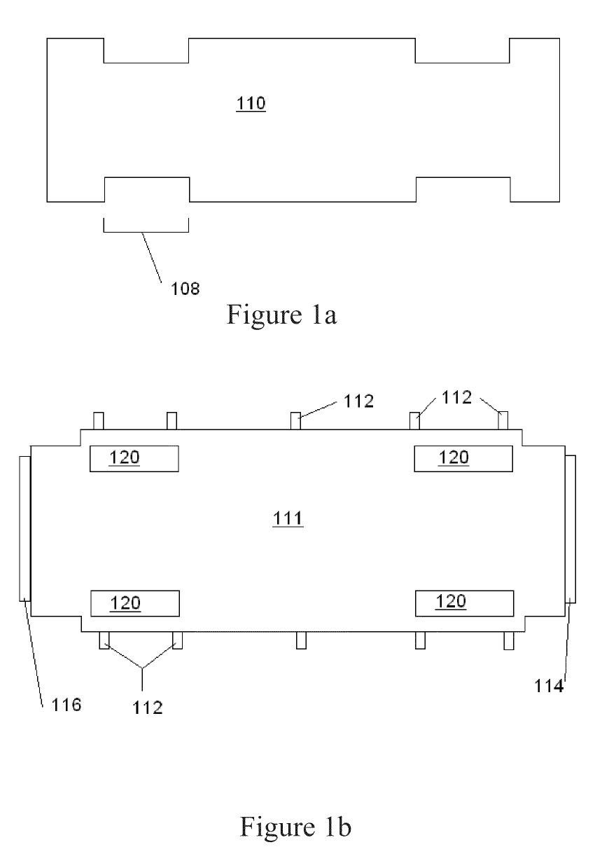

FIGS. 1a-1b illustrate block diagrams of vehicle underbody panels in accordance with various embodiments. As shown in FIG. 1a, a vehicle underbody panel may comprise a panel 110. Panel 110 may be attached to a vehicle to cover a portion of the vehicle's underbody. Attachment of panel 110 may reduce drag by covering features of the vehicle undersurface that would otherwise disrupt air flow beneath the vehicle. Panel 110 may comprise gaps 108 to accommodate vehicle tires/wheels.

Panel 110 may be constructed from any flexible material as described above. Panel 110 may be shaped to accommodate features of any make or model of automobile. For example, panel 110 may be shaped to accommodate vehicle tires (e.g. the center of the panel wider than the front end and/or rear end of the panel).

FIG. 1b shows a panel 111 with wheel apertures 120, side fasteners 112, a rear fastener 116 and a front fastener 114. One or more side fasteners 112 may be coupled to panel 111 for attachment of panel 110 below a vehicle. Similarly, one or more front fasteners 114 and/or rear fasteners 116 may be coupled to panel 111 for attachment of panel 111 below a vehicle. In various embodiments, side fasteners 112, front fasteners 114 and/or rear fasteners 116 may comprise one or more fastening mechanisms such as a hook-and-loop fastener, a hook, a snap, a latch, a buckle, a tie, and/or other fastener known in the art. In some embodiments, a side/front/rear fastener may comprise a hook coupled to a panel, and the hook may be fastened to a surface feature or component of the vehicle (e.g. a bumper, a door frame, a chassis, a grill, a trailer hitch, etc.).

Panel 111 may lack one or more of front/side/rear fasteners. For example, in some embodiments panel 111 may lack side fasteners and may comprise a tensioning mechanism at the front/back of panel 111. A panel may include any number and combination of front/side/rear fasteners. Alternatively, a panel may lack any front/side/rear fasteners. In some embodiments, a panel lacking fasteners (e.g. panel 110 of FIG. 1a) may be positioned along the underbody of a vehicle using a separately provided/applied fastener. For example, a disposable panel lacking fasteners may be permanently or reversibly coupled to the underbody of a vehicle using an adhesive, and then removed for access to the underbody.

Although not shown, a panel may be configured with one or more openings, for example to provide access to the vehicle underbody, such as to change the engine oil, etc.

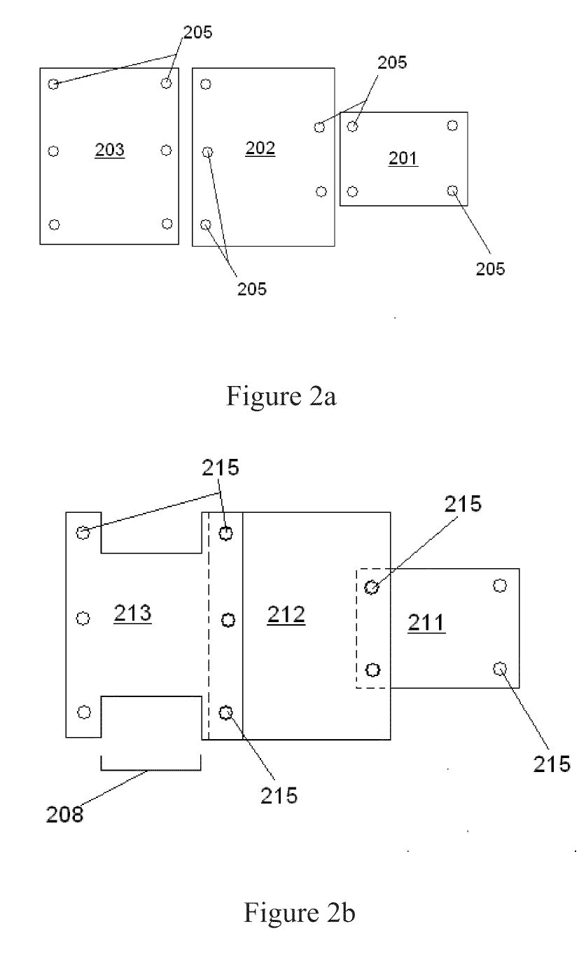

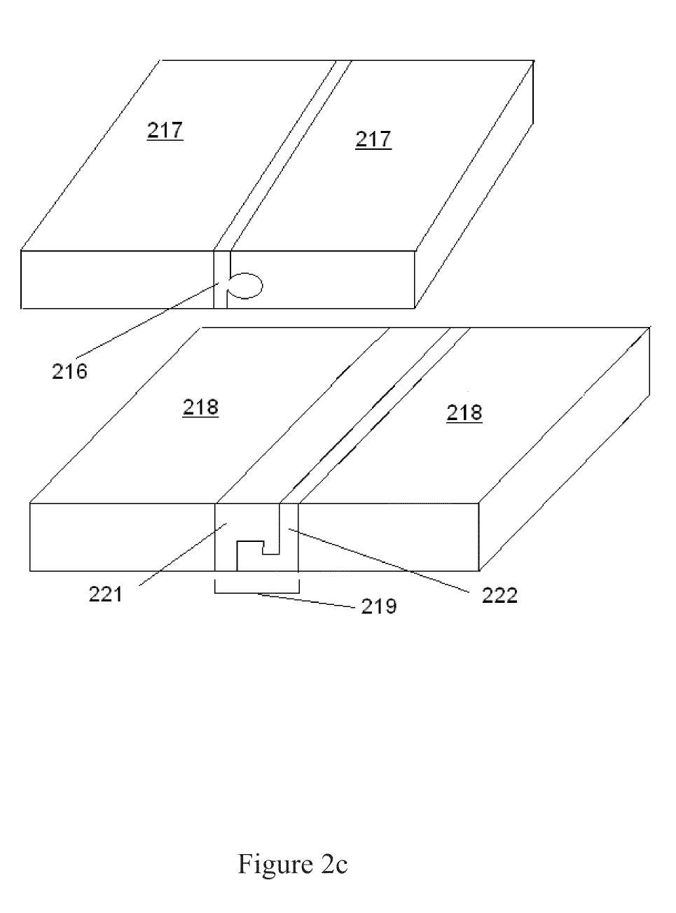

FIGS. 2a-2b illustrate multi-section vehicle underbody panels in accordance with various embodiments. As shown in FIG. 2a, a multi-section vehicle underbody panel 200 may comprise a front panel 201, a middle panel 202, and a rear panel 203. In the illustrated embodiment, front panel 201 may be configured to be retained in a position below a forward frame section of a vehicle. Middle panel 202 may be configured to be retained in a position below a middle frame section of a vehicle. Rear panel 203 may be configured to be retained in a position below a rear frame section of a vehicle. Panels may or may not be configured to overlap, as desired. Any or all of front panel 201, middle panel 202, and rear panel 203 may comprise one or more panel coupling elements 205 and/or may be shaped with one or more gaps 208 to accommodate tires or other vehicle features/protrusions. Arrangements of panel coupling elements shown in the figures are merely exemplary, and a panel may comprise one or more panel coupling elements in any suitable configuration.

Front panel 201 may be shaped/sized to cover a portion of a vehicle front and underbody extending from one or more features at the front of the vehicle (e.g. a hood, bumper, fender, or grill) to another one or more features of the underbody such as the drive shaft, flywheel, differential, or front axle. Middle panel 202 may be shaped/sized to cover a portion of a vehicle underbody corresponding to the location of the transmission, the area between the front and rear tires or below the passenger compartment, etc. Rear panel 203 may be shaped/sized to cover a rear portion of a vehicle such as an area between a rear bumper/trunk and a portion of the underbody corresponding to the location of the transmission.

Panel coupling elements 205 may be fasteners and/or may retain one or more fasteners. In some embodiments, a panel coupling element 205 may comprise an aperture extending through at least part of the thickness of the panel. In an embodiment, an aperture of a panel coupling element 205 may be used to retain a fastener. In other embodiments, panel coupling element 205 may comprise at least one portion of a fastener (e.g. one part of a snap, latch, buckle, etc.) configured to mate with another portion of the fastener located on another panel and/or on a vehicle component. In various embodiments, a vehicle underbody panel may comprise one, two, three, four or more panels.

A panel may be coupled to another panel and/or to a vehicle by one or more fasteners (e.g. by panel coupling elements 205 or panel coupling elements 215) and/or other by any suitable coupling element known in the art. For example, as shown in FIG. 2b, a front panel 211 may be coupled to a middle panel 212, and middle panel 212 may be coupled to a rear panel 213, by panel coupling elements 215. Panel coupling elements 215 may comprise a fastener or a portion of a fastener configured to mate with another portion located on another panel and/or vehicle component. Alternatively, a panel may be coupled to another panel and/or to a vehicle by a fastener disposed along an edge of the panels and/or on the vehicle. FIG. 2c shows a perspective view of two panels 217 joined by a panel coupling element 216, and two panels 218 joined by a panel coupling element 219. A panel coupling element may comprise a single coupling element, such as panel coupling element 216. Alternatively, a panel coupling element may comprise two or more coupling elements. For example, as shown, panel coupling element 219 may comprise first panel coupling member 221 and second panel coupling member 222.

Panel coupling element 216, panel coupling element 219, first panel coupling member 221 and/or second panel coupling member 222 may be separate components coupled to an edge of a panel or to a vehicle. Alternatively, panel coupling element 216, panel coupling element 219, first panel coupling member 221 and/or second panel coupling member 222 may be formed in a panel or on a vehicle as an integral part of the panel/vehicle (e.g. by removing material from the panel, by adding material during manufacture, by molding/shaping during manufacture, etc.). A panel coupling element may allow panels to be uncoupled by sliding one panel with respect to another. For example, in a vehicle underbody panel comprising three panels, a panel coupling element 216 or a panel coupling element 219 may allow a panel to be uncoupled by pulling/pushing the panel laterally (e.g. toward the left or right side of the vehicle) along a substantially horizontal plane.

FIG. 3 illustrates a cutaway profile view of a vehicle underbody airflow modulator positioned on a vehicle chassis in accordance with various embodiments. As shown, a vehicle underbody airflow modulator may include a tensioning device 330, tensioning fasteners 340, a tensioning device coupler 350, and a panel 310 with a first end 311 and a second end 313.

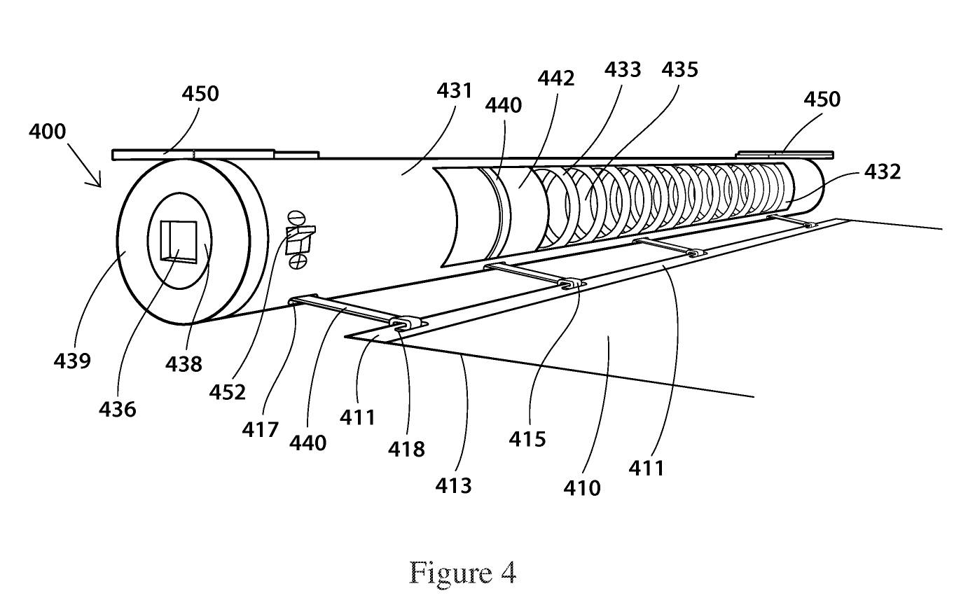

First end 311 of panel 310 may be coupled to tensioning device 330, which may be coupled to a vehicle chassis 335 or to a vehicle body or other vehicle component directly or by tensioning device coupler 350. Tensioning device coupler 350 may be any fastener and/or combination of fasteners and other elements (e.g. a plate and screws, a clamp, etc.). Panel 310 may be coupled to tensioning device 330 by tensioning fasteners 340 (see also FIG. 4), which may comprise any type of fastener. Tensioning device 330 and/or tensioning device coupler 350 may extend across the full length and/or width of the vehicle, or may extend only partially along the length and/or width of the vehicle. In some embodiments, panel 330 may be positioned below most or all underbody components (e.g. final drive axle, transmission, suspension, etc.) to minimize Cd and maximize fuel efficiency.

Second end 313 may be coupled to terminal bracket 360, and terminal bracket 360 may be coupled to vehicle chassis 335 or to a vehicle body or other vehicle component. For example, terminal bracket 360 may be coupled to a final drive unit 336 in a position below/behind the final drive unit 336, retaining second end 313 of panel 310 below/behind final drive unit 336 and minimizing or eliminating chafing of panel 310. In some embodiments, one or more terminal brackets 360 or other panel supporting features (e.g. auxiliary brackets 370) may be coupled to a spring-mounted vehicle component, such as a spring-mounted final drive unit (e.g. final drive unit 336).

Auxiliary brackets 370 may be included in some embodiments. Panel 310 may slide over and/or under an auxiliary bracket 370. In embodiments, the auxiliary brackets may retain panel 310 below various undercarriage protrusions and/or prevent physical contact between panel 310 and the protrusions. Auxiliary brackets 370 may lift panel 310 in one or more locations, such as at the forward terminus of the drive shaft. Auxiliary brackets 370 and/or terminal brackets 360 may be double brackets and may be positioned both under and over panel 310. Auxiliary brackets 370 and/or terminal brackets 360 may stabilize the panel in high velocity air flow conditions.

FIG. 4 illustrates a partial cutaway perspective view of a tensioning device for use with a vehicle underbody panel, in accordance with various embodiments. In FIG. 4, portions of the housing are removed to show interior features of the device. As illustrated, a tensioning device 400 may comprise a housing 431 with an interior chamber 435 and one or more interior surfaces 432, an end cap 438, and an end cap fastener 439. End cap fastener 439 may have a tensioning input 436. A spring member 433 and a spool 442 may be disposed within the interior chamber 435. Spring member 433 may be coupled at one end to an interior surface 432. Spring member 433 may also be coupled to end cap 438, end cap fastener 349, and/or spool 442. One or more tensioning fasteners 440 may be coupled to spool at a first end and may pass through a housing aperture 417. A second end of tensioning fasteners 440 may be coupled to a panel 410 by couplers 415. Couplers 415 may be any type of fastener. In some embodiments, couplers 415 may be releasable fasteners. Tensioning device 400 may also comprise a control 452 for increasing/decreasing tension on tensioning fasteners 440.

Panel 410 may have one or more side edge reinforcing features 413 and/or end reinforcing features 411, such as a double thickness of panel material, a seam, stitches, an adhesive, and/or additional material coupled to panel 410. Panel 410 may comprise one or more holes 418 to accommodate a fastener or other coupling element, such as a coupler 415. One or more tensioning device couplers 450 may be coupled to housing 431 for coupling tensioning device 400 to a vehicle.

In some embodiments, end cap 438 and/or end cap fastener 439 may comprise a ratchet that may be turned to load energy into spring member 433. In an embodiment, end cap 438 and/or end cap fastener 439 may comprise a reversible ratchet allowing unloading of energy from spring member 433. Alternatively, spring member 433 may be coupled to a tension loading and/or unloading device disposed within interior chamber 435. A tension loading/unloading device may be coupled to a spring member or other energy storing device and/or to control 452.

One or more spools 442 may be disposed within interior chamber 435. Spring member 433 may be arranged within one or more spools 442, along the exterior of one or more spools 442, and/or positioned in any other arrangement with spools 442. Spring member 433 may be coupled to a spool 442, and turning of end cap 438, a ratcheting device, and/or end cap fastener 439 may turn spool 442. Tensioning fasteners 440 may be coupled to one or more spools 442 such that turning spools 442 causes tensioning fasteners 440 to be wound on spools 442.

Tensioning input 436 may be shaped to accommodate a tensioning tool such as a torque wrench, a crank, a lever, or other mechanism. Input of energy into end cap 438, end cap fastener 439, and/or tension loading device by turning or activating a device coupled to tensioning input 436 may load energy into spring member 433 or other energy storing device. As the device is turned, tensioning fasteners 440 (such as comprising one or more cables) may be wound around one or more spools 442 disposed within interior chamber 435. An outer end of tensioning fasteners 440 may be coupled to panel 410. Tensioning fasteners 440 may be constructed from any suitable material, such as a metal, wire, woven wire, carbon fiber, a polymer, etc.

As tension is increasingly applied to spring member 433, tensioning fasteners 440 may increasingly apply lateral tension to panel 410. In various embodiments, a standard torque reading may be engineered and/or assigned for use in an application. Some embodiments may include two or more tensioning devices such as tensioning device 400. In other embodiments, other tensioning devices may be used instead of, or in combination with, tensioning device 400. For example, a tensioning device 400 may be combined with a strap and/or a fastener to tension a panel. Some embodiments may include one or more other tensioning mechanisms, such as a strap and buckle, strap and hook, etc.

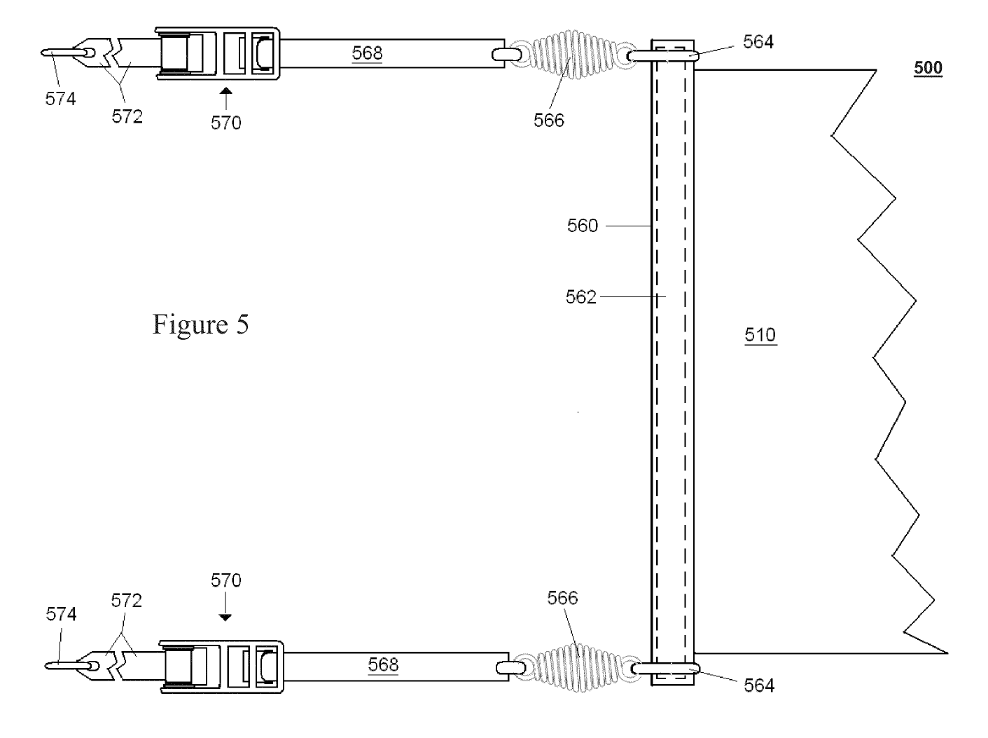

FIG. 5 illustrates a partial plan view of a tensioning device for use with a vehicle underbody panel in accordance with various embodiments. As illustrated, a vehicle underbody airflow modulator 500 may comprise a panel 510 with an end portion 560, a support 562, spring members 566, first straps 568, a tensioning element 570, second straps 572, and couplers 564 and 574.

Panel 510 may have one or more edge and/or end reinforcing features, holes, or other features described above with regard to panel 410. End portion 560 may be coupled to panel 510 by any means known in the art (e.g., with an adhesive, stitching, welding, melting/pressing, etc.). Alternatively, end portion 560 may be an integral portion of panel 510. For example, panel 510 and end portion 560 may be a single piece of a material. End portion 560 may form a sleeve or tube that is closed at one or both ends or is open at both ends. Support 562 may be permanently or removably positioned within end portion 560 as shown.

Support 562 may be a rigid or semi-rigid component such as a bar. Support 562 may be cylindrical, flat, curved, or have any other suitable shape. In some examples, support 562 may be/include a leaf spring positioned to flex in response to vertical force while remaining comparatively rigid in response to horizontal force, or vice versa. Alternatively, support 562 may be a rigid or semi-rigid rod, such as a tie rod. Either or both of end portion 560 and support 562 may have one or more holes or other features configured to receive a coupler 564. Couplers 564 and 574 may be any type of fastener known in the art, including but not limited to a hook, a chain, a loop, a strap/tie, a rivet, a screw, a tie wrap, a ring clamp, or other fastener. Couplers 564 may be coupled at one end to support 562 and/or end portion 560, and may be coupled at another end to springs 566.

Springs 566 may be extension springs, coil springs, or any other component configured to store energy in response to applied tension. Springs 566 may be coupled to first straps 568. First straps 568 may be coupled to tensioning elements 570, which may in turn be coupled to second straps 572. First straps 568 and/or second straps 572 may be made of any natural, synthetic, or semi-synthetic material, such as nylon, polypropylene, polyester, or other material known in the art. Tensioning elements 570 may include a ratchet configured to load energy into spring members 566, such as a reversible ratchet buckle. Alternatively, tensioning elements 570 may include a cam fastener, a spring fastener, a side release fastener, or another tensioning device/fastener.

Second straps 572 may be coupled to couplers 574. Couplers 574 may be configured to be retained by a vehicle component (e.g., a body component, a frame/chassis component, a drive train component, an axle, a bumper, a fender, an interior feature, etc.). Alternatively, another component such as a hook, strap, hitch, or plate may be coupled to the vehicle and configured to retain couplers 574.

Panel 510 may be suspended below the underbody of a vehicle by coupling one end of panel 510 to a first end of the vehicle (see e.g., FIG. 3) and coupling the other end of the panel to a second part of the vehicle via couplers 574. As tensioning elements 570 are operated, the length of second straps 572 (or first straps 568) may be decreased until first and second straps 568/572 are taut. Additional operation of tensioning elements 570 may load energy into spring members 566. This may apply tension to panel 510 and other components to retain vehicle underbody airflow modulator 500 in position below the vehicle.

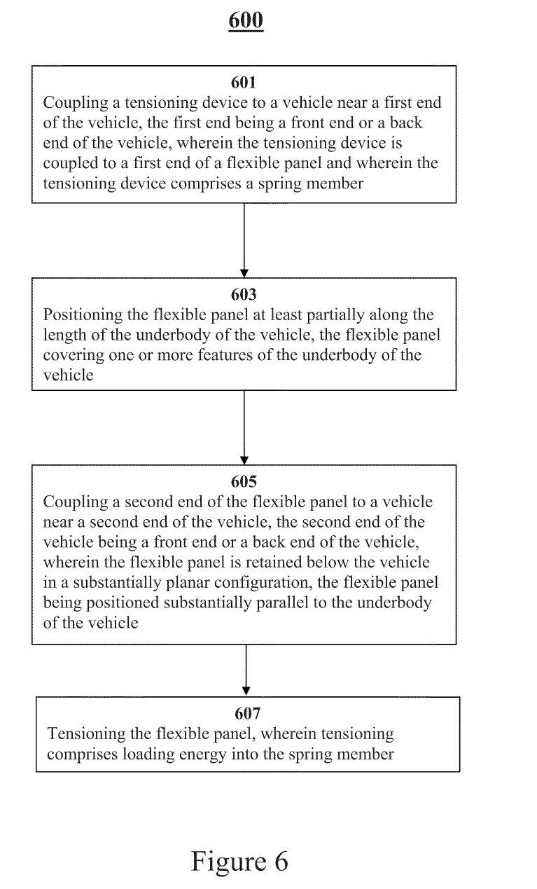

FIG. 6 illustrates a method for reduction of aerodynamic drag on a vehicle in accordance with various embodiments. At block 601, a tensioning device may be coupled to a vehicle at or near a first end of the vehicle, the first end being a front end or a back end of the vehicle, wherein the tensioning device is coupled to a first end of a flexible panel and wherein the tensioning device comprises a spring member. A tensioning device may be any suitable device or fastener as described herein. Next, at block 603, the flexible panel may be positioned at least partially along the length of the underbody of the vehicle, the flexible panel covering one or more features of the underbody of the vehicle. At block 605, a second end of the flexible panel may be coupled to the vehicle at or near a second end of the vehicle, the second end of the vehicle being a front end or a back end of the vehicle, and the panel may be retained below the vehicle in a position substantially parallel to the underbody of the vehicle. Finally, at block 607, the flexible panel may be tensioned at least in part by loading energy into the spring member. In some embodiments comprising self-tensioning fasteners (e.g. elastomers) for coupling the panel to the vehicle, block 607 may be omitted. In other embodiments, a tensioning device may lack a spring member and may be another type of fastener, such as a strap and buckle, strap and hook, etc. In an embodiment, tensioning the flexible panel may comprise tightening a strap/fastener by pulling or otherwise manipulating the strap.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. For example, in some embodiments a vehicle underbody panel may comprise one or more panels configured for coupling to features such as a bumper, a trailer hitch, or other vehicle features with an elastic tie and/or hook. In other embodiments, a vehicle underbody panel may be retractable, either manually or automatically, along one or more tracks/wires/channels disposed along a vehicle underbody. For example, in one embodiment, an accordion-pleated or rolled panel may be coupled along opposite side edges to wires or other elements within tracks/channels. The tracks/channels may be disposed in parallel along a vehicle underbody (e.g. from bumper to bumper), with a tensioning device at a front end and another at a back end of the vehicle. The tensioning devices may be synchronized such that as one increases tension to spool/retract the panel, the other releases tension, allowing the panel to be extended or retracted. A housing may be provided for storage of the retracted panel. The tensioning devices may be controlled manually and/or automatically (e.g. through an interior vehicle control, a remote control, etc.).

Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

What is claimed is:

1. A vehicle underbody apparatus, comprising:
a flexible panel having a front end, a back end, and two sides;
one or more coupling elements coupled to at least one of the front end and the back end of the flexible panel; and
a tensioning device coupled to the coupling elements, the tensioning device configured to apply tension to the flexible panel.

2. The vehicle underbody apparatus of claim 1, wherein the tensioning device comprises a ratchet.

3. The vehicle underbody apparatus of claim 2, wherein the tensioning device comprises a spring member.

4. The vehicle underbody apparatus of claim 1, wherein the tensioning device is releasably coupled to the coupling elements.

5. The vehicle underbody apparatus of claim 1, wherein the coupling elements are releasably coupled to the flexible panel.

6. The vehicle underbody apparatus of claim 1, wherein the tensioning device comprises a hollow cylinder.

7. The vehicle underbody apparatus of claim 6, wherein the tensioning device further comprises a releasable ratchet.

8. The vehicle underbody apparatus of claim 1, further comprising a second flexible panel, the second flexible panel configured to be coupled to the first flexible panel.

9. The vehicle underbody apparatus of claim 1, further comprising a bracket configured to retain the panel below the underbody of a vehicle.

10. The vehicle underbody apparatus of claim 1, wherein the tensioning device is configured to be mounted to the vehicle.

11. The vehicle underbody apparatus of claim 1, wherein the coupling elements are configured to couple to the vehicle.

12. A method of reducing drag, the method comprising:
coupling a tensioning device to a vehicle at or near a first end of the vehicle, wherein the tensioning device is coupled to a first end of a flexible panel and wherein the tensioning device comprises a spring member; and
coupling a second end of the flexible panel to the vehicle at or near a second end of the vehicle, wherein the panel is retained below the vehicle in a substantially planar configuration.

13. The method of claim 12, further comprising tensioning the flexible panel, wherein tensioning comprises loading energy into the spring member.

14. The method of claim 12, wherein the first end of the vehicle is a front end of the vehicle.

15. The method of claim 12, wherein the first end of the vehicle is a back end of the vehicle.

16. The method of claim 12, wherein coupling the second end of the flexible panel comprises coupling a second tensioning device to the second end of the vehicle.

17. The method of claim 13, wherein the tensioning device includes a ratchet mechanism, and wherein loading energy into the spring member comprises operating the ratchet mechanism.

18. The method of claim 12, wherein the panel is retained in a position substantially parallel to an underbody surface of the vehicle.
